(19) United States
(12) Patent Application Publication
(10) Pub. No.: US 2013/0280976 A1
(43) Pub. Date: Oct. 24, 2013

(54) STRUCTURAL SUBSTITUTES MADE FROM POLYMER FIBERS

(71) Applicant: Nyloboard LLC, Covington, GA (US)

(72) Inventors: Eric McCann, Oxford, GA (US); Daniel L. Hartman, Covington, GA (US); Kishorchandra C. Dave, Covington, GA (US); Edwin P. Hill, Woodstock, GA (US); Kevin M. Guthard, Greensboro, GA (US)

(21) Appl. No.: 13/843,624

(22) Filed: Mar. 15, 2013

Related U.S. Application Data
(63) Continuation-in-part of application No. 12/873,666, filed on Sep. 1, 2010.

(51) Int. Cl. B32B 27/12; B32B 27/04

(52) U.S. Cl. CPC B32B 27/12; B32B 27/04
USPC 442/288; 428/297.4; 428/300.7; 442/396; 264/257; 425/112

(57) ABSTRACT

A method for creating a material sheet with fibers includes the steps of feeding a layer of loose fibers to a conveyor; applying a resin to the loose fibers, the resin being capable of bonding to the loose fibers; conveying the loose fibers and resin to a mold; and allowing the resin applied to the loose fibers to fill the mold and then solidify to harden in a desired thickness.

### CROSS-REFERENCE TO RELATED APPLICATIONS

This application is a continuation in part of application Ser. No. 12/873,666, filed Sep. 1, 2010, the entire contents of which are incorporated herein by reference.

### BACKGROUND OF THE INVENTION

This invention is in the field of solid materials handling, and relates to using material (for example, recycled material from discarded carpet segments) to create structural materials of various shapes and sizes. Preferably, the material is highly resistant to infiltration or damage by water and various chemicals and solvents.

Various methods are known for converting recycled waste products containing nylon and other polymers into relatively narrow planks. Those recycled planks typically resemble single boards, and typically have widths only up to about 15 cm (6 inches) wide. Most manufacturing processes used to create such planks from recycled wastes require a relatively high level of melting of the nylon or other plastic material in the recycled feedstock mixture. Accordingly, such manufacturing processes require large amounts of energy, primarily to heat the recycled materials to their melting points.

By contrast, prior to this invention, there have been few successful or widely accepted methods of converting nylon or other waste material into sheets with high strength, durability, high but non-brittle levels of hardness and rigidity, etc. A number of important and previously insurmountable obstacles apparently have prevented any such efforts from succeeding. Some of those obstacles can be summarized as follows.

Prodigious amounts of energy are required to heat the bulk and volume of material that would be involved in large-scale manufacturing of wood substitutes, to the high temperatures that would be necessary in a manufacturing operation that requires extensive melting of recycled plastic or synthetic feedstock material.

Even if the necessary “average” temperatures could be reached, non-uniform heating would lead to unacceptable fault lines, fracture zones, weak spots, and other flaws, when large sheets of hard material are being manufactured. If wood-like sheets are being created, those flaws would result in uneven strength, poor quality, and unreliability in ways that do not occur when narrow planks are created using melt-and-mold processes as used in the prior art.

The problem of uneven heating (and resulting poor quality) is aggravated by the fact that when matted layers of fibers are heated, they respond in a manner directly comparable to thick woolen blankets. Fibrous mats are thermal insulators, and the type of thermal insulation they provide will thwart and frustrate any effort to establish the type of uniform and consistent heating that is required for a melt-and-mold manufacturing operation.

Serious problems arise when attempts are made to mix different types and grades of discarded nylon, and/or various other types of recycled plastics. As one example, in recycling operations used to create narrow planks of wood-like materials, care must be taken to avoid mixing a form of nylon called “nylon-6” with a slightly different form of nylon called “nylon-6,6.”

For these and other reasons, most prior efforts to create large sheets of wood-like material from discarded carpet segments (or other recycled textiles) by melting apparently have failed. A comparable item that is available for sale is a synthetic waterproof sheet, made from highly expensive materials such as never-before-used spun fiberglass, held together with large quantities of expensive adhesives. Such sheets are sold as premium waterproof construction materials, by companies such as Coosa Composites LLC (Pelham, Ala.), at prices which average about $125.00 (wholesale price) for a single sheet which is ½ inch thick, and which is the same size as a standard sheet of plywood (4 ft.×8 ft., or about 1.2 m×2.4 m). Conventionally, low levels of filler are used, whereas the present invention uses an average of 33% to 50% filler by weight, as will be discussed more fully below.

There are some known forms of making large sheets of material without melting the nylon fibers. As discussed in U.S. Patent Application Publication No. 2004/0224589 A1, which is incorporated herein by reference, in one embodiment a continuous sheet of matted fibers can be sent through a needle-punching machine in order to create a needle-punched mat. The mats can then be layered with adhesive. Multiple mats can be layered together. The mats are then pressed together and kept compressed until the adhesive has cured and hardened enough to establish the final thickness. In another disclosed embodiment, nylon fibers blended with polyolefins, such as polypropylene (which is commonly used in carpet backing), are heated to a certain temperature causing only the polyolefins to melt, which causes the polyolefins to act as an adhesive.

The results eventually achieved have shown that discarded carpet segments can be processed to create inexpensive but very strong sheets of wood-like construction materials, which have strength, durability, and handling traits (including the ability to withstand nails or screws near an edge without splitting or fracturing), which are comparable to wood, and in some respects substantially better than wood. In addition, since this material is made from nylon and other hydrophobic synthetic fibers, it is much more resistant than normal plywood to infiltration or damage by water. However, previously, the plywood-like materials were incapable of being made without either needle-punched mats or melting the nylon fibers.

Synthetic v. Natural Fibers

Nylon is the primary type of synthetic fibers discussed herein, because nylon tufting material is used in a large majority of carpets that use synthetic fibers. However, any references herein to “nylon” should be regarded as being merely exemplary of synthetic fibers as a class. Other types of synthetic fibers (such as polyethylene terephthalate, sold under the trademark DACRON, and polyacrylonitrile, sold under the trademark ORLON) also can be used to make wood-like materials, using the procedures described herein.

The manufacturing operations described herein can be performed most economically, on a large commercial scale, if all of the fibers used are synthetic (i.e., are derived from petrochemicals or similar chemical feedstocks). However, a primary factor in this preference relates to explosion and flammability risks that arise when natural fibers (such as cotton, linen, etc.) are used. Additional concerns with the use of natural fibers are the inherent tendency to wick moisture and provide a food source for insects, mold, spores, and fungal microbials. Recycling and manufacturing plants designed for use with natural fibers must use special venting, air handling, dust control, and similar equipment, to minimize the risks of explosions or fires.

Although such equipment can be installed in a recycling facility that handles both synthetic and natural materials, it is assumed for the present time that, at least in industrialized nations where large quantities of carpet are used and discarded, a shredding and manufacturing facility as described herein should limit its feedstock, so that it will only accept and work with synthetic fibers, such as discarded carpet segments, synthetic textiles, etc. In addition to helping reduce the risk of explosion or fire, this step can also help ensure that the wood-substitute materials manufactured in that facility will have high levels of resistance to water infiltration and damage, since cotton, linen, wool, rayon (which is derived from cellulose), and most other natural fibers tend to be more hydrophilic (water-attracting) than nylon, polypropylene, polyesters, and most other synthetic fibers.

Since some natural fibers (such as wool and rayon) do not pose the same explosion and fire risks that are posed by cotton, the operators of any shredding and/or manufacturing facility can determine whether discarded materials made from any such material can be used safely as a suitable feedstock for that particular facility.

Shredding Machines, Feedstocks, and Product Grades

The process disclosed herein was initially developed and tested using carpet segments that had been shredded by a particular type of shredding system. That system, which uses a claw drum followed by two drums with abrading surfaces rotating at different speeds, is described in U.S. Pat. No. 5,897,066, which is incorporated herein by reference.

The shredded material generated by that system provided excellent results in creating high-grade material sheets. However, it is anticipated that various other machines and/or methods for shredding discarded carpet segments (or other types of synthetic fibrous feedstocks) may also be suitable for use as described herein, for producing at least some grades of wood substitute materials. Many different types of processes are known for removing fibers from carpet backing, such as shaving, use of a hammermill machine, etc.

Accordingly, specific methods of shredding or of post-shredding processing (such as the “opening” or “pulling” steps that are carried out by “Laroche” and garnett machines, described below) are not crucial to this invention. Any suitable shredding or opening machine or method can be used, if it will provide shredded and/or “opened” fibrous material that can be processed as described herein to generate a material sheet having acceptable quality for at least some types of uses.

It also should be kept in mind that shredding operations that will be adequate for non-carpet textiles (such as clothing, drapes, bedsheets, etc.) are likely to be substantially easier (and less abrasive to the machinery involved) than carpet shredding operations.

Accordingly, the output material from any type of shredding machine (or any other processing machine that is used after the initial shredding step, and before the needle-punching step), when performed on a particular type of carpet or other textile feedstock, can be evaluated as disclosed herein, using no more than routine experimentation, to determine whether that output material can be used to generate construction materials with acceptable consistency and reliability to satisfy the quality needs for a useful grade of construction material.

If desired, carpet segments (or other recycled textiles) that are very dirty, greasy, or badly mildewed, or suffer from other problems can be processed by means of a washing process, using steam and/or other solvents; this can be followed by a drying process, if desired.

It also should be noted that several types of feedstocks can be used, which are generated during carpet manufacturing operations but do not involve finished carpet. As one example, substantial quantities of “yarn waste” are generated by carpet manufacturers. This type of “yarn waste” is usually accumulated on large spools, for storage and handling. In a recycling facility, this yarn waste can be removed from the spools by an unwinding operation, or by a cutting operation. It can then be used as feedstock in the manufacturing operations described herein, using steps that can be adapted to the particular type and quality of the yarn waste being processed. As an example, yarn waste that has been removed from spools by a cutting operation, which will generate strands that typically range from about 1 to about 3 feet long, can be fed directly into the 3-cylinder shredder system described below; however, the material that emerges from that machine may not need to be passed through a “waste puller” machine (also called a “Laroche” machine) to further open up the fibers.

Accordingly, the present invention can provide a practical and economical method of using discarded carpet segments or other textiles (preferably including only synthetic fibers) to make large sheets of material that are comparable to wood in terms of strength and weight, but which are more resistant than plywood or lumber to water infiltration and damage.

The present invention can provide a more cost-effective way of producing sheets of material, by eliminating the preliminary step of needle-punching mats of fibers.

The present invention can provide a practical and economical method of making a wood substitute of any desired size, from fibers, preferably from discarded carpet segments.

The present invention can provide methods of making water-resistant wood substitutes in sheets which are highly resistant to cracking, and which will not lose strength if a crack forms on one side, or near an edge.

The present invention can provide methods of making water-resistant wood substitutes in sheets of any desired size, with a range of density, hardness, insulating, and other traits, by controlling various manufacturing parameters that determine the final thickness, density, and hardness of the resulting material.

The present invention can provide methods of making water-resistant wood substitutes in sheets which can be as large as desired, such as a single waterproof sheet large enough to form the entire deck of a large boat, or an entire roof or floor of a large truck trailer or recreational vehicle.

The present invention can provide methods of making building materials which can substitute for wood, thereby eliminating the need to harvest trees to manufacture those materials.

The present invention can provide a commercially feasible and economic method of reducing and even entirely eliminating the solid waste problem created by millions of tons of carpet segments and other discarded synthetic fabrics that are currently being sent to landfills every year.

These and other features of the invention will become more apparent through the following summary, drawings, and description of the preferred embodiments.

### SUMMARY OF THE INVENTION

A method is disclosed for using discarded carpet segments or other recycled textiles (preferably made of nylon or other synthetic fibers) to make structural materials in large sheets that are comparable in some respects to, for example, plywood. The carpet segments or other recycled materials are shredded, and then layered transversely across a slow-moving conveyor system, to form a wide, thick, low-density belt of loose fibers.

In one embodiment, loose fibers are fed to a conveyor belt and an adhesive capable of mechanically bonding to the loose fibers is poured onto the loose fibers. Then, the loose fibers mixed with the adhesive are conveyed to a mold.

According to one aspect of the invention, a method for creating a material sheet with fibers comprises the steps of feeding a layer of loose fibers to a conveyor; applying adhesive to the loose fibers, the adhesive being capable of mechanically bonding to the loose fibers; conveying the loose fibers and adhesive to a mold; and allowing the adhesive applied to the loose fibers to expand while containing the adhesive applied with the loose fibers in the mold in a manner to cause the adhesive to permeate throughout the fibers and to harden in a desired thickness.

According to another aspect of the invention, an article of manufacture suitable for use as a wood substitute comprises a sheet of composite material consisting essentially of an adhesive compound which has become bound to a layer of non-matted, loose fibers.

According to another aspect of the invention, a system for creating a material sheet with fibers comprises a supplying system that supplies loose fibers; a conveyor system that conveys the loose fibers; an adhesive system that applies adhesive to the loose fibers; and a mold system that allows the adhesive applied to the loose fibers to expand while containing the adhesive applied with the loose fibers in the mold in a manner to cause the adhesive to permeate throughout the fibers and to harden in a desired thickness, wherein the supplying system supplies the loose fibers to the conveyor system to be conveyed to the adhesive system and then the mold system.

### BRIEF DESCRIPTION OF THE DRAWINGS

FIG. 1 illustrates the system of forming material sheets from loose fibers.

FIG. 2 illustrates a side view of a supply hopper.

FIG. 3 illustrates a gravity hopper with photoreceptive sensors.

FIG. 4 is a flowchart for determining the level of the loose fibers in the gravity hopper.

FIG. 5 illustrates an example bar conveyor.

FIGS. 6a and 6b illustrate a front view and a side view, respectively, of a leveling rake assembly.

FIGS. 7a and 7b illustrate a top view and a side view, respectively, of the static mix tube manifold for pouring adhesive.

FIGS. 8a and 8b illustrate is a top view and a cross-sectional view, respectively, of the mold.

FIG. 9 illustrates the controller system for controlling the various components of the entire system.

FIGS. 10a and 10b are side views of the completed material sheet, with and without skins.

FIGS. 11a and 11b illustrate a modified embodiment of the system of forming material sheets from loose fibers.

### DETAILED DESCRIPTION OF THE PREFERRED EMBODIMENTS

This invention relates to a method, apparatus and system of using shredded material from discarded carpet segments (or possibly other textiles) to make wood-like materials, in a variety of shapes and sizes.

As used herein, terms such as “discarded” and “recycled” are used interchangeably. These terms refer to any type of fibrous material that is used as a feedstock in a manufacturing operation as described herein. Such materials include rolls or segments of carpet, as well as bales, piles, or any other aggregations of fabrics, textiles, or other fibrous materials. Such recycled material may be, or include, post-consumer material that has been discarded in a used and worn condition; alternately, it may be, or include, never-used material, such as material discarded because of imperfections, because it did not sell, because it became tailing or side-trim scrap, or for any other reason. Also, fibers may be made specifically for this application and need not come from any recycled material.

The term “wood-like materials” describes output materials that are made from discarded or otherwise recycled carpet segments, or from other types of textiles, such as synthetic and natural fabrics, and include certain attributes of wood, such as rigidity, the ability to be machined, the ability to hold nails and screws, etc.

As used herein, the term “sheet” is used to describe a manufactured item of any size. In this context, the term “sheet” implies that the manufactured item will be in a relatively flat, planar form, unless specific steps are taken to create a different shape.

It should also be noted that in various settings, “oversized” sheets of seamless material can be very useful. As one example, various types of vans, recreational vehicles, buses, trucks and trailers, and other vehicles likely would be quieter, and less expensive to build, if the entire floor unit could be built on top of a single sheet of strong seamless material, especially if that material can provide an inherently high level of thermal and sound insulation. Additional advantages may arise from making the entire roof from a single sheet of seamless material, and/or from making one or more side or end walls from a single sheet of strong seamless material.

As another example, various types of boats would be safer, stronger, and more seaworthy, if an entire deck or hull portion was made from a single sheet of seamless waterproof material. For example, complex shapes with multiple contours can be cast by a split mold, such as a clam shell concept, as long as either half of the mold does not prevent the ability to remove the casting from the mold.

In addition, oversized sheets of material made as described herein could be highly useful in making “prefabricated” houses or other buildings. If an entire wall, or an entire floor segment, ceiling layer, or roof portion could be created from a single sheet of seamless material with inherent thermal and sound insulation, the cost savings and other benefits would be substantial.

In discussing the potential advantages of the materials disclosed herein, it should also be noted that these materials are ideally suited for use with screws and nails, and with drills, saws, hammers, and other tools. Since they are made from a large number of strong fibers, rather than from a brittle, glass-like, or ceramic-type material, these materials will not shatter, crack, or split when a nail or screw is hammered or driven therethrough, even at a location very close to an edge.

Indeed, in that respect, the materials disclosed herein can out-perform wood products in their ability to resist cracking and splitting. Due to the unique homogeneous closed cell construction, no laminations or grain patterns exist; therefore, damage inflicted on any particular area of the material is not transferred to surrounding areas by way of natural stress lines as would be experienced in wood or laminated products.

In all of these respects, these materials appear to be able to far out-perform wood or plywood, in terms of strength and durability in response to high stress or other assaults. And, in addition to being highly tolerant of nails and screws, they offer good surfaces for painting, gluing, or other chemical coatings or bondings. Accordingly, in all respects, these materials appear to offer excellent and in many respects superior substitutes for wood, plywood, particleboard, planks, or other conventional construction materials.

Material Composite Sheets Made with Adhesives

In one preferred embodiment, material composite sheets can be made by using adhesives that will mechanically or chemically bond to loose synthetic fibers. In another embodiment, any type of loose fibers may be used.

If certain types of adhesives discussed below are used, the combination of the loose fibers and the adhesive can create premium grade (or even super-premium) sheets which are highly resistant to water, salt water, and most solvents and other chemicals. These sheets can also be made with very high levels of hardness, durability, and other traits. Alternately, if different adhesives are used, they can create wood-like sheets that have different physical and/or performance traits, but which can nevertheless be useful and valuable as building materials.

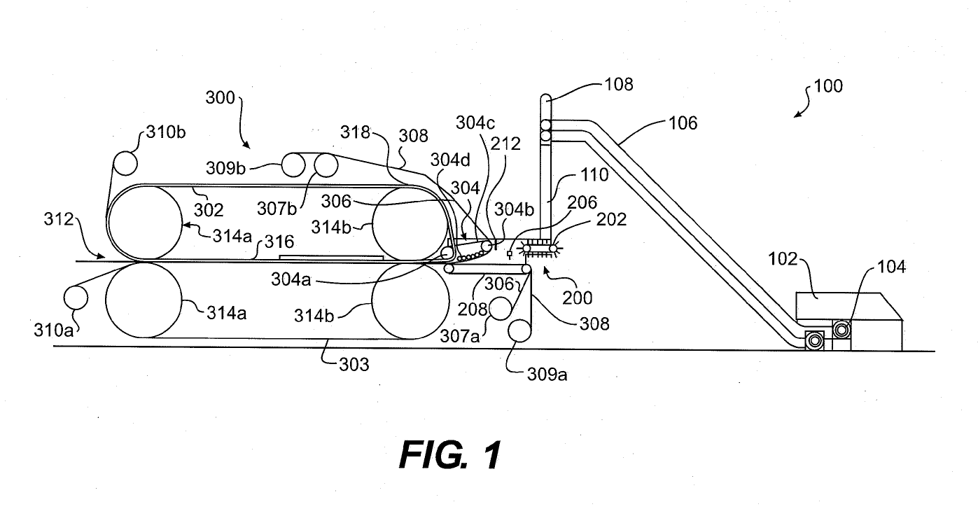

In one embodiment, a supply system 100 provides loose fibers to a conveyor system 200, which conveys the loose fibers to an area where adhesive is poured on the loose fibers. The conveyor system 200 then continues to convey the loose fibers to a mold system 300 to form a sheet of material. The overview of the system is shown in FIG. 1.

Supply System

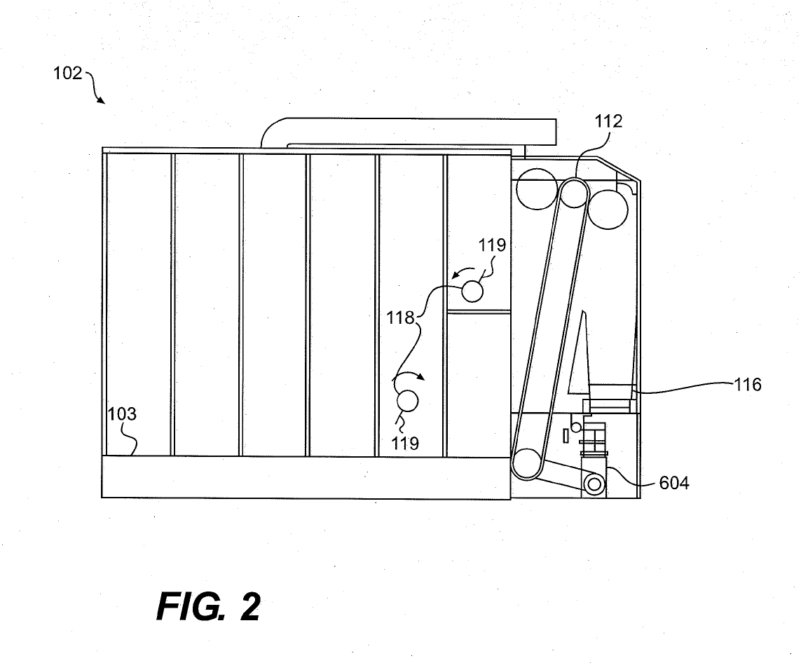

In the supply system 100, shown in FIG. 1, fibers are stored in a conventional supply hopper 102, blown via ducts 106 to a gravitational hopper 110, and fed to a conveyor system 200 to have adhesive poured on the loose fibers. The supply hopper 102, also known as a bale beater, may be a conventional mixing chamber provided by OBR Belmatex. Supply hoppers are known in the art; therefore, only a brief description thereof will be given. In a preferred embodiment, the loose fibers are provided from discarded carpet segments; however, the loose fibers may be any other synthetic or natural fibers. A side view of a simplified supply hopper 102 is shown in FIG. 2. The supply hopper 102 may include one or more rods 118 that rotate to create a more manageable loose material from bales of fibers placed in the supply hopper 102. The rods 118 are placed horizontally through the supply hopper 102. Bales of fibers are fed to a conveyor belt 103 in the supply hopper 102. The conveyor belt 103 is shown merely as a flat surface for simplicity. The bales of fiber are then conveyed toward the one or more rods 118. Even more preferably, rods 118 turn in opposite directions. The rods 118 generally have a row of six or more bars 119. By the movement of the one or more rods 118 and the attached bars 119, the bales of fibers are beat into loose fibers that are a manageable loose material to allow the loose fibers to more easily be blown by the blowers 104. That is, the bars 119 act as an impact surface or stirring stick to break the compacted baled fiber into loose fibers. At least one armature motor 602 (not shown in FIG. 2) is used to drive and rotate the one or more rods 118 in a circular manner. The armature motor 602 is controlled by a controller 600, as will be discussed below.

The supply hopper 102 contains a gate 112, as shown in FIG. 2. At least one motor 604 is attached to the gate 112 to open and close it, depending on a signal sent from the controller 600. The gate 112 is closed to keep the loose fibers in the supply hopper 102 or opened to allow the loose fibers to proceed to ducts 106. The gate 112 is closed and the ducts 106 are cleared prior to shutting down the whole assembly so as to prevent stalling during a restart of the assembly. The gate 112 may consist of a conveyor system with moving rollers to move the fibers to an exit 116 to pneumatic blowers 104, as shown in FIG. 2. As shown in FIG. 2, the loose fibers, once beaten by the rods 118, are conveyed to the gate 112. The fibers are conveyed up a conveyor belt which has attached bars, or an equivalent structure (not shown), to grasp and lift the fibers up through the rollers of the gate 112 and down to the exit 116.

Attached to the supply hopper 102 is a transportation system to transport the loose fibers from the supply hopper 102 to the gravitational hopper 110. The transportation system consists of the gate 112, at least one but preferably two or more ducts 106, and pneumatic blowers 104. Plural ducts 106 allow the loose fibers to be more evenly distributed in the gravitational hopper 110, which will, in turn, help the flow of the system. The loose fibers are fed directly into the pneumatic blowers 104, which may be squirrel cages, or centrifugal blowers, for example. However, any type of blowers 104 may be used to transport the loose fibers from the supply hopper 102 to the gravitational hopper 110 via ducts 106. When the loose fibers pass through the blowers 104, the blowers 104 move the loose fibers in an air stream through the ducts 106 to the gravitational hopper 110. The blowers 104 are controlled by a signal sent from a controller 600, as will be discussed more fully below.

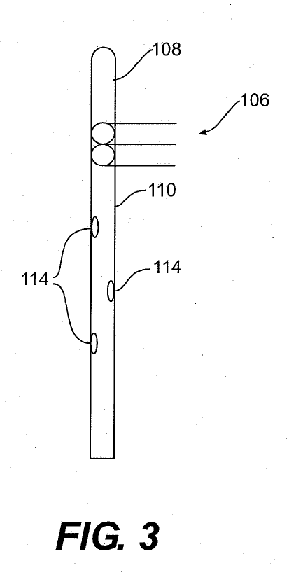

Referring to FIG. 1, the gravitational hopper 110 acts as a vertical hold station for the loose fibers blown by the blowers 104. An exhaust stack 108 is provided at the top of the gravitational hopper 110 to allow gravitational separation of air and the loose fibers. This allows the air stream to exhaust and the loose fibers to accumulate at the bottom of the gravitational hopper 110. The air is filtered and ducted harmlessly away from the process line while the loose fibers, with the assistance of both air pressure from the ducts 106 and gravitational force, drop into the gravitational hopper 110 to be further processed. In one embodiment, the gravitational hopper 110 is 8.2 feet wide, 1 foot across and 12 feet high. However, the gravitational hopper 110 may be any size necessary to store the loose fibers and provide a steady supply of loose fibers during the manufacturing process. The gravitational hopper 110 also may contain photoreceptive sensors 114, as shown in FIG. 3, in order to sense the level of the loose fibers in the gravitational hopper 110. The photoreceptive sensors 114 may be installed in several locations in the gravitational hopper 110, as shown in FIG. 3.

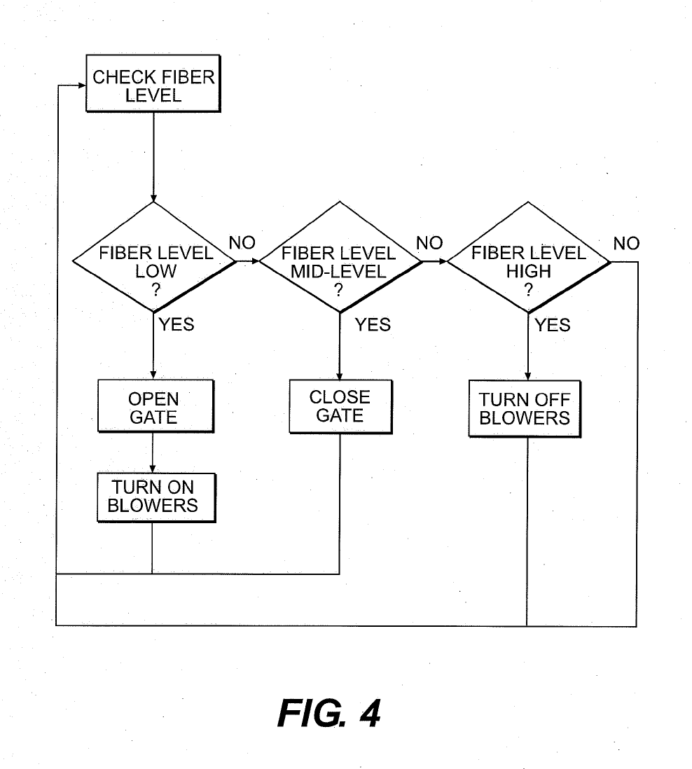

As shown in the flowchart in FIG. 4, if the photoreceptive sensors 114 indicate that the amount of loose fibers in the gravitational hopper 110 is below a minimal level, the controller 600 will then open the gate 112 in supply hopper 102 and turn on the pneumatic blowers 104 so that the loose fibers will be blown by the pneumatic blowers 104 through the ducts 106 to the gravitational hopper 110. If the photoreceptive sensors 114 indicate that the amount of loose fiber in the gravitational hopper 110 is at a mid-level, the controller 600 will close the gate 112. Once the photoreceptive sensors 114 indicate that the amount of material in the gravitational hopper 110 has reached the maximum level, the controller 600 will then turn off the pneumatic blowers 104. By delaying the shut off of the blowers 104 after the gate 112 is closed, most of the loose fibers can be cleared from the ducts 106 to prevent clogging during the next start up.

Conveyor System

The loose fibers in the gravitational hopper 110 are fed to the conveyor system 200 by gravity. The conveyor system 200 conveys the loose fibers from the gravitational hopper 110 to a mold system 300. The conveyor system 200 helps maintain the continuous flow of the loose fibers from the gravitational hopper 110 to the mold system 300.

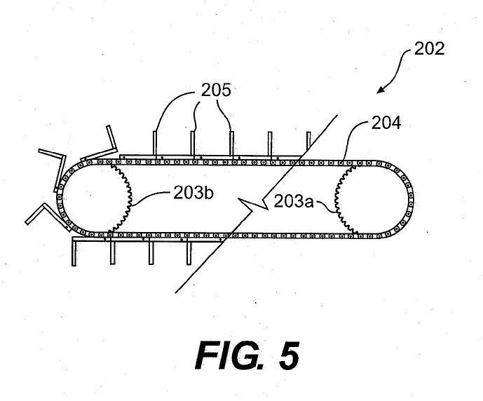

The conveyor system 200 includes, at the bottom of the gravitational hopper 110, a short length, full width bar conveyor 202, as shown in FIG. 1 and in more detail in FIG. 5. The bar conveyor 202 is a conveyor belt 204 with a variety of bars 205 attached perpendicular to the transport direction of the belt. The bars 205 can be made from any material. For example, the bars 205 can be made out of the sheets produced as disclosed in this application. The height of the bars 205 on the bar conveyor 202 may be adjusted according to the desired density of the loose fibers to be supplied to a pour table 208. The higher the desired density of the loose fibers, the more loose fibers that must be conveyed onto the pour table 208 per a given area. Therefore, the bar height of the bar conveyor 202 will be higher. The height of the bars 205 is changed by replacing the current set of bars 205 on the bar conveyor 202 with a different set of bars of a different height. The bars 205 may be slideably removed and inserted onto the bar conveyor 202.

As shown in FIG. 5, the bars 205 of the bar conveyor 202 are formed in an “L” shape. One portion of the “L” sits on the conveyor belt 204 and the other portion is perpendicular to the conveyor belt 204. This “L” shape creates a tray for the fibers to be received from the gravitational hopper 110. The smaller the height of the bars 205, the less space there is available for the loose fibers in the tray. Therefore, the density of the loose fibers conveyed to the pour table 208 will be less. As the conveyor belt 204 rotates, via gears 203a and 203b, the trays dump the loose fibers stored in the trays on to the pour table 208.

The speed of the bar conveyor 202 is also adjusted according to the bar 205 height and the required density of the loose fibers on the pour table 208 at a given area. At least one motor 606 is attached to the gears 203a and 203b to rotate the bar conveyor 202. The controller 600, as will be discussed more fully below, controls the speed of the bar conveyor 202. The higher the density of the loose fibers needed, the slower the bar conveyor 202 will rotate to accommodate filling the more voluminous trays created by the bars 205 of the bar conveyor 202.

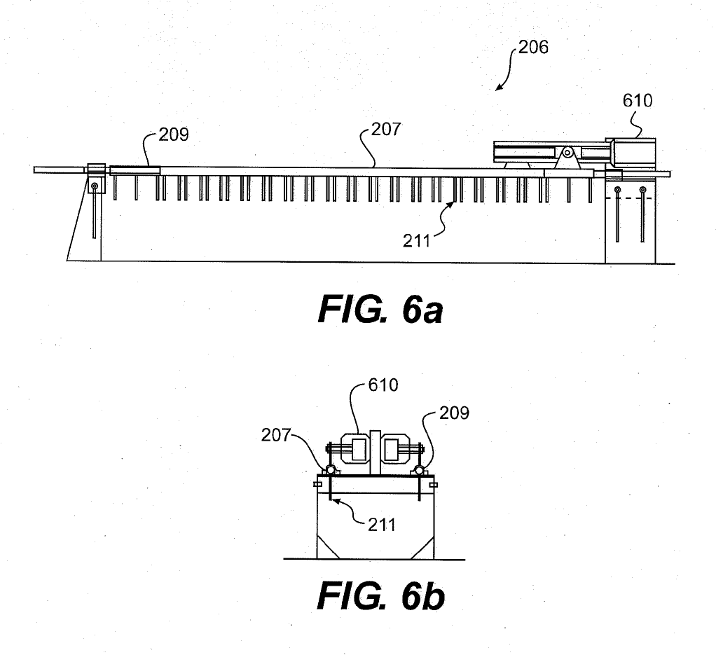

The bar conveyor 202 conveys the loose fibers to the pour table 208. The pour table 208 is a conveyor belt, driven by at least one motor 608, to convey the loose fibers to an area where adhesive is poured on the loose fibers and further to the mold system 300. After the loose fibers are conveyed to the pour table 208, a leveling rake 206, shown in FIGS. 6a and 6b, levels the loose fibers before entering the mold. The leveling rake 206 may be a two bar reciprocating rake. At least one motor 610 is attached to drive the leveling rake 206. The two bars 207, 209 of the two bar reciprocating rake 206 are connected to linear bearings and move in a linear motion back and forth relative to each other via motor 610. This causes the blades 211 attached to the two bars 207, 209 of the two bar reciprocating rake 206 to drag across the loose fibers on the pour table 208 in order to level the loose fibers. The speed of the pour table motor 608 and the leveling rake motor 610 are coordinated. The controller 600 will control the speed of both motors so that the speed of the pour table 208 is tied to the speed of the leveling rake 206. The height of the leveling rake 206 can be adjusted by hand or automatically, for example, to accommodate different densities of fibers needed on the pour table 208. If done automatically, the controller 600 will determine the necessary height of the leveling rake 206 and a motor 611 will be attached to adjust the height of the leveling rake 206 based on a signal from the controller 600. If the density of the loose fibers is to be higher, then the height of the leveling rake 206 can be raised to level the loose fibers. If the density of the loose fibers is to be lower, then the leveling rake 206 can be lowered to level the loose fibers. Although the leveling rake 206 has been described as a two bar reciprocating rake, the leveling rake 206 is not limited to this configuration. The leveling rake 206 may be any device, such as a rotational device, for metering the loose fibers.

Adhesive Application System

Once the loose fibers have been leveled by the leveling rake 206, the loose fibers continue to be conveyed by the pour table 208 toward the mold system 300. Prior to entering the mold system 300, an adhesive is added to the loose fibers.

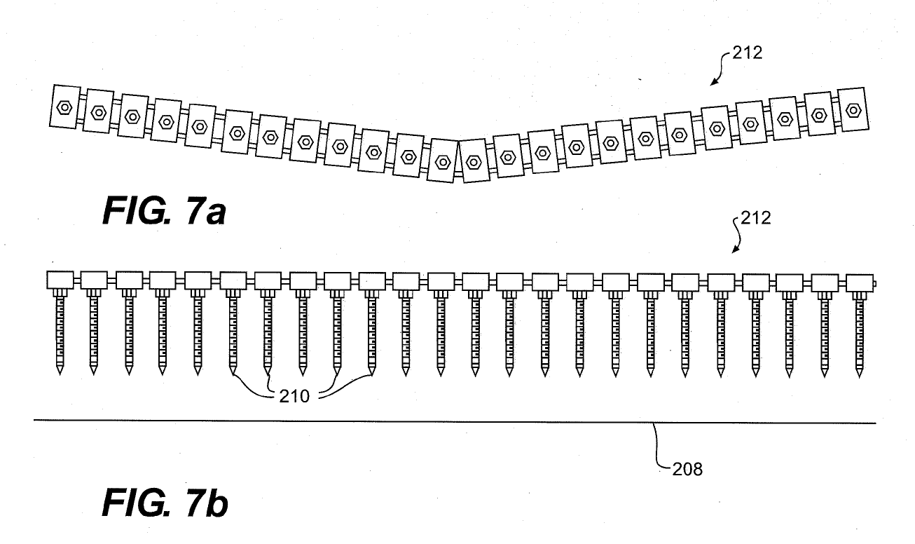

In a preferred embodiment, the adhesive is poured on the loose fibers via static mix tube manifold 212 shown in FIGS. 7a and 7b. The adhesive is stored in a storage container and is poured onto the loose fibers by at least one nozzle 210. The static mix tube manifold 212 preferably includes a plurality of nozzles 210, as shown in FIG. 7b, and is preferably formed into a “V” shape to create a “V” pattern for pouring the adhesive onto the loose fibers, as shown in FIG. 7a. The adhesive is poured onto the loose fibers located on the pour table 208 at a rate to create a defined level of the adhesive as it is poured. Therefore, the layer of adhesive poured will have a certain height. Calculating the necessary height of the adhesive will be discussed later.

The “V” pattern allows the adhesive to be contacted in the middle of the loose fibers on the pour table 208 first before entering the mold. This also allows the adhesive to be poured onto the center of the loose fibers at a different time from when the adhesive is poured on either side of the center. Preferably, the wide portion of the “V” pattern would be poured closest to the mold, when moving in the process direction, as shown in FIG. 7a. This allows the point of the “V” to begin pouring adhesive on the loose fiber first.

When the center of the “V” pattern is upstream in the conveying direction of the fibers, the adhesive is poured in the center of the loose fibers first, so the adhesive in the center will begin to react within the central loose fibers before the adhesive immediately adjacent the center. This allows the adhesive to foam and expand from the center of the loose fibers and push the air from the middle of the loose fibers toward the outside of the loose fibers as the adhesive begins to react away from the center. This creates a timing difference between when the adhesive at the center of the loose fibers will be cured compared to the outside. The removal of the air from the center outward as the material is forming helps eliminate voids caused by air or gases between the exteriors of the material sheet. However, any pour shape may be used to pour the adhesive onto the loose fibers. For example, the point of the “V” pattern may also be poured closest to the mold, or the nozzles may be laid out in a straight line rather than a “V” pattern.

It is believed that a foaming reaction of the adhesive, which occurs when a layer of the adhesive is poured on the loose fibers, will substantially increase two very useful processes: (i) permeation and penetration of the adhesive into the loose fibers, and (ii) intimate contact and tight mechanical or chemical bonding between the adhesive and the loose fibers. Accordingly, foaming adhesives can enable and promote the manufacture of large sheets that have high levels of uniformity, consistency, and strength, in which any weak spots or fracture zones will be minimized or eliminated, to an extent that cannot be achieved in the absence of a foaming reaction, even when high pressure is applied.

In a preferred embodiment, a foaming mixture of isocyanate and polyol (hereinafter polyurethane foam) is used as the adhesive. Polyurethane foam has an inherent bonding affinity for nylon. This allows for materials that are exceptionally hard, strong, and durable.

Mold System

After the adhesive has been poured on the loose fibers, the pour table 208 conveys the loose fibers mixed with the adhesive to the mold system 300. Prior to entering the mold, a mechanical assist 304 may be provided to assist with pre-compression of the loose fibers mixed with the adhesive. As discussed above, the adhesive is added immediately prior to entering the mechanical assist 304. The mechanical assist 304 is designed to provide 100% compression of the loose fibers and adhesive, substantially eliminating air in the mixture prior to entering the mold, as further described below. The mechanical assist 304 will compress the loose fibers mixed with the adhesive to a desired thickness of the material sheet so that the loose fibers mixed with adhesive maintain their shape in the mold 316 as the adhesive is cured to the desired hardness. The mechanical assist 304 may comprise a belt 304c, as shown in FIG. 1, or a release film, discussed more fully below, may act as the belt for the mechanical assist 304. The mechanical assist 304 also comprises rollers 304a and 304b to guide the belt 304c. The mechanical assist 304 may also contain additional guide rollers 304d shown in FIG. 1.

The gauge of the mechanical assist 304 is adjustable to produce a variety of sizes of the material. The gauge may be calculated by the total volumetric mass cross-section of all the solids and liquids entering the mechanical assist 304. Depending on the calculations, the gauge is adjusted through the mold 316, discussed more fully below, by either lifting the mechanical assist 304 to accommodate a higher gauge or by lowering the mechanical assist 304 to accommodate a lower gauge. Alternatively, the loose fibers poured with adhesive may enter the mold 316 without first going through a mechanical assist 304.

Typically, boards are produced with a pound per cubic foot (PCF) density in the range of 20 PCF to 50 PCF, for example. Then, it must be determined what thickness is desired for the board (generally ¼″, ⅜“, ½”, ⅞″, 1″ and 1⅛″). Further, as discussed below, skins may be added to meet other structural requirements of the boards. Pounds per square foot of the board is determined by taking the PCF and dividing it by the desired thickness. The height of the total of the loose fibers, skins and adhesive can be determined from the weight per cubic foot and the rate of application. Then, the mechanical assist 304 will be set to this height to allow only the loose fibers, skins and adhesive to pass under the mechanical assist 304 to remove air. The percent of loose fibers by weight is averaged between 33% and 50%, for example.

The mold 316 comprises a set of steel belts 302, 303, as shown in FIG. 1. Each steel belt 302, 303 is fitted around at least two rollers 314a, 314b. Each steel belt 302, 303 is moved by the rollers 314a, 314b, which are driven by at least one motor 612 and controlled by the controller 600.

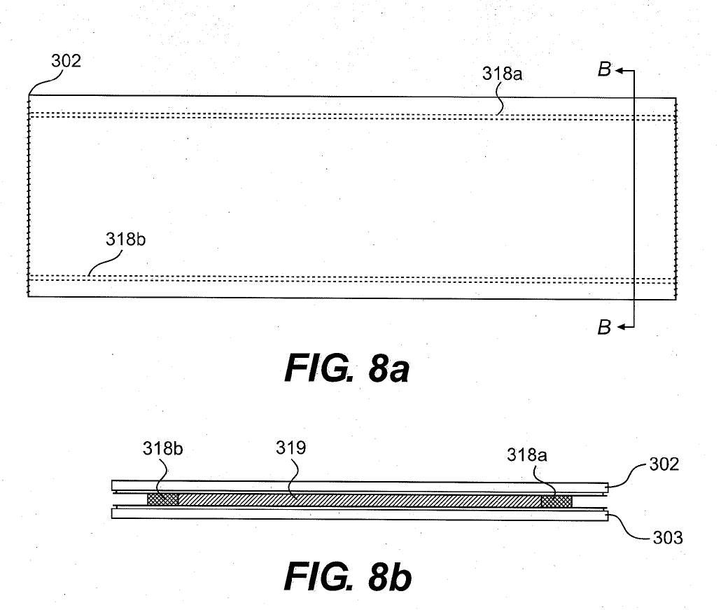

A set of containment belts 318a, 318b are fitted around steel belt 302. The containment belts fit around the length of the steel belt, but also incorporate part of the mechanical assist 304, as shown in FIGS. 1, 8a, and 8b. FIGS. 8a and 8b are not drawn to scale for simplicity purposes. One containment belt 318a is fitted at one outer edge of the steel belt 302 and the other containment belt 318b is fitted at the other outer edge of the steel belt 302. If a mechanical assist 304 is provided, each containment belt is also fitted around part of the mechanical assist 304. As discussed above, the mechanical assist 304 helps provide compression of the loose fibers poured with adhesive prior to entering the mold. The containment belts 318 are preferably made of hybrid polyuria. FIG. 8a shows a top view of the steel belt 302 with the containment belts 318a, 318b. As can be seen in FIG. 8a, a containment belt 318a, 318b is located on each of the outer edges of the steel belt 302. Further, the front end portions of the containment belts 318a, 318b wrap around the roller 304a, with the mechanical assist belt 304c in between the containment belts 318a, 318b. The containment belts 318a, 318b, however, are not limited to being located around steel belt 302. In an alternative arrangement, the containment belts 318a, 318b may be located around steel belt 303.

The loose fibers poured with adhesive are conveyed through the mold 316. As the loose fibers are conveyed through the mold 316, the adhesive chemically reacts and expands within the loose fibers, forming the material sheet. The steel belts 302, 303 of the mold 316 convey the loose fibers mixed with the adhesive through the mold 316 while the adhesive is cured. The steel belts 302, 303 limit the expansion of the adhesive in the vertical direction, while the containment belts 318 limit the expansion of the adhesive in the horizontal direction, thereby creating pressure within the mold 316. This can be seen in FIG. 8b, which is cross-section at section line B-B of FIG. 8a of the mold 316. FIG. 8b shows the steel belts 302, 303 and the containment belts 318a, 318b. The containment belts 318a, 318b encase the sides of the loose fibers poured with adhesive 319, while the steel belts 302, 303 encase the top portion of the loose fibers poured with adhesive 319.

In one embodiment, the steel belt 302 has vents located at set distances, for example, approximately every six inches. However, the vents may be any desired distance apart. The vents allow the air or gas that is pushed out from the loose fibers, as discussed above, to exhaust as the material sheet is being formed.

In one embodiment, the containment belts 318a, 318b are belt segments attached end to end by a chain-like joint. Therefore, each containment belt is formed of a plurality of belt segments. These belt segments allow for easy placement of the mechanical assist 304 gauge. During a gauge adjustment, the mold can be stopped and the nearest belt segment of the containment belts 318a, 318b may be opened so that the gauge of the mechanical assist 304 can be adjusted. Further, the mold is set to be at a height to allow the fibers to expand slightly beyond the desired thickness of the board. This will allow the board to be sanded down to the desired thickness, as will be discussed more fully below in the example.

In a preferred embodiment, the containment belts 318a, 318b should be separated by a distance slightly greater than the desired width of the material sheet being produced so as to contain the material, but not unduly restrict the mold space. The use of belt segments, discussed above, allow for easy replacement of the containment belts 318 if the size needs to be changed. Therefore, the containment belts 318 can easily be changed segment by segment, rather than having to replace the containment belts 318 as a whole.

As shown in FIG. 1, the mold system 300 further includes at least one roller, preferably two, 307a, 307b, which store release film and/or paper (hereinafter referred to as release film 306). The rollers 307a, 307b that store the release film 306 have at least one motor 614 attached to rotate the roller. The release film 306 is preferably made of polyethylene. The release film 306 protects the material sheet from potentially sticking to the steel belts 302 after being formed. Preferably, the release film 306 is provided on a roller 307a below the loose fibers and on a roller 307b above the loose fibers poured with adhesive. This will allow the release film 306 to be located on both sides of the loose fiber. As shown in FIG. 1, the release film 306 is wound around the pour table 208 so that the fibers are conveyed directly onto the release film 306 on the pour table 208 (unless a lower skin is used, as discussed below.) Further, if release film 306 is provided on a roller 307b above the loose fibers, the release film 306 is wound around the mechanical assist 304 and is provided above the loose fibers after they have been poured with adhesive. The release film allows the product to cleanly release from the belts 302.

The release film 306 is preferably a reusable type of release film. After the release film 306 is fed through and exits the mold, the release film 306 originally fed from roller 307a will be wound around roller 310a, and the release file 306 originally fed from roller 307b will be wound around roller 310b, as shown in FIG. 1, to be used again. The rollers 310a, 310b will be provided with at least one motor 618 to help with the rewinding of the release paper. The release film 306, for example, is preferably a film of high density polyethylene.

Further, as shown in FIG. 1, the mold system 300 may also include at least one roller, preferably two, 309a, 309b which may store a skin 308. As shown in FIG. 1, one roller 309a will feed the skin 308 so that the release film 306 is below the skin, and the loose fibers are poured onto the skin 308. The other roller 309b will feed the skin 308 around the release film 306, which is wound around the mechanical assist 304, to be located on top of the loose fibers and below the release film 306. The skins 308 provide further structural support for the material sheets and will be chosen based on the desired properties of the material sheet. Each of the rollers 309a, 309b will be controlled by a motor 616 connected to the controller 600.

As will be understood by one of ordinary skill in the art, a single skin 308 may be provided below the fibers with release film 306 provided above the fibers. Further, multiple skins 308 may be provided on a variety of rollers. As will be understood by one of ordinary skill in the art, a variety of combinations may be made between the release film 306 and the skins 308 provided to form the material sheet.

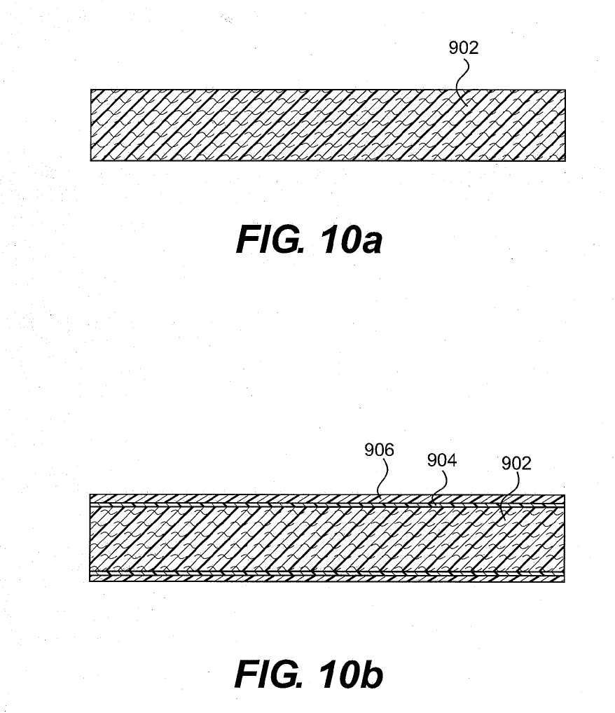

The skins 308 can be a porous technical fabric. After the skin is laid on or below the loose fibers, the adhesive will expand through the pores of the skin 308. The skin 308 is then embedded in the adhesive on top of the loose fibers. If multiple skins 308 are used, the adhesive will expand through the pores of all of the skins 308. The skins 308 will then be embedded in the adhesive, layered on top of the loose fibers. Refer, for example, to FIGS. 10a and 10b, which show the layers of various types of boards. FIG. 10a shows a sheet formed with loose fibers and adhesive, without a skin. FIG. 10b shows a material sheet formed with multiple layers of skins 308 and loose fibers embedded in the adhesive.

The skins 308 may include, but are not limited to, for example, E-glass veil skin, woven E-glass roven skin, carbon fiber technical skins, Kevlar, Nomex fire retardant skin, non-woven E-glass roven skin, embossed wood grain skin, polyester cloth, cotton cloth, polypropylene veil mesh, aluminum screen, nylon mesh, paper, tissue paper, blast resilient skin, and fragmentation resistant skin. Any skin may be used that is formed of an inert, fibrous and porous material, for example.

For example, FIG. 10a shows a material sheet formed out of loose fibers mixed with adhesive 902. FIG. 10b shows a material sheet formed with loose fibers mixed with adhesive 902, with a layer of non-woven E-glass Roven 904 in the adhesive and a layer of E-glass veil 906 in the adhesive.

Controller System

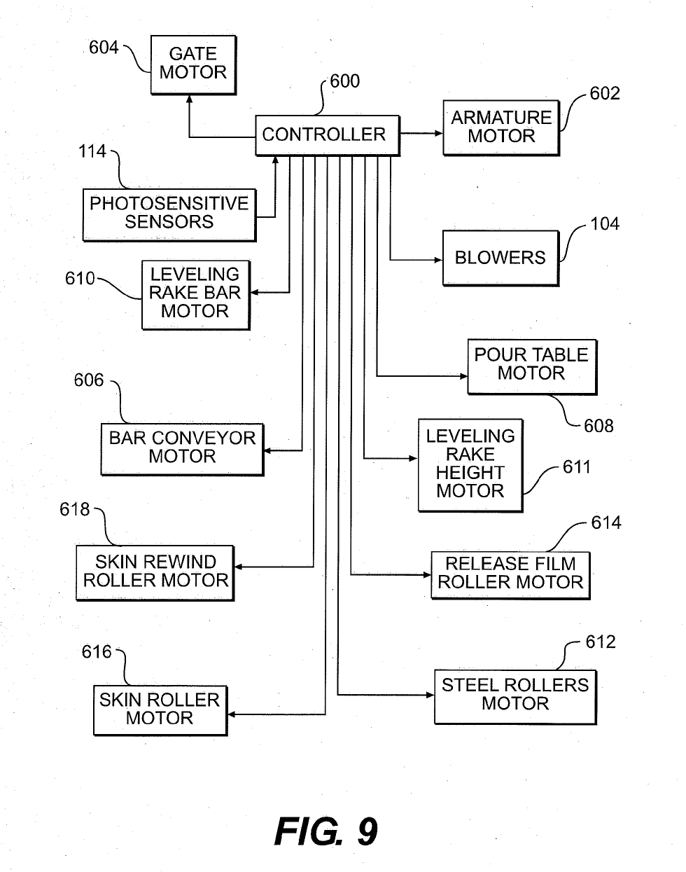

As discussed above, the system is provided with at least one controller 600; however, as understood by one of ordinary of skill in the art, multiple controllers 600 that interact with each other may be provided. As shown in FIG. 9, the controller 600 controls the various aspects of the system as a whole. The controller can be a suitably programmed microprocessor.

For example, the controller 600 receives signals from the photosensitive sensors 114 located in the gravitational hopper 110. Depending on the signals received, the controller 600 controls the gate 112 of the supply hopper 102 and blowers 104. The controller also controls the speed of the rods 118 to beat the material into manageable loose fibers.

The controller 600 will control the speed of the bar conveyor 202 depending on the speed needed for the bar conveyor 202 to produce the desired density. The controller 600 will also control the speed of the leveling rake 206 to be tied to the speed of the pour table 208.

As shown in FIG. 9 the controller 600 will provide signals to the motors associated with the various rollers, to move the rollers in a way to allow smooth operation of the loose fibers moving through the mold and applying the skin 308 and/or release film 306 to the loose fibers. The controller 600 will operate the various components of the system to run in unison.

All of the components of the system, including, for example, motors, conveyor belts, chemical flow rate valves, etc., are program controlled based on sensor and/or operator inputs. This level of automation allows the sequencing of events to avoid process stalls as well as product consistency. The controller 600 is connected to a control panel for an operator to input the desired commands for running the entire system.

### Example

In one example, to make a ½ in. thick material sheet, the desired total weight of the board, which is identified as pounds per cubic foot (PCF), must first be determined. To make a 40 PCF, ½ in. material sheet with fiberglass technical fabric for a skin, 1.2948 pounds of adhesive per square foot must be added to the loose fibers and skin to meet the necessary design criteria. This is determined by calculating the total weight per square foot of solid materials and subtracting the total from the desired total weight of the board, which would be 1.667 pounds per square foot (which is determined by converting 40 PCF for a ½ in. material sheet to pounds per square foot). If the fiberglass technical fabric weighs 24 ounces per square yard, the loose fibers weigh 26 ounces per square yard, and an exterior E-glass veil weighs 3.6 ounces per square yard, adding to 53.6 ounces per square yard, or 0.3722 pounds per square foot, this leaves the abovementioned 1.2948 pounds of adhesive per square foot out of the total 1.667 pounds per square foot of the desired weight of the board.

In one example, to make a ½ in. material sheet, fibers will be fed from the gravitational hopper 110 to the bars on the bar conveyor 202. The bars on the bar conveyor 202 will be set to an appropriate height. The speed of the bar conveyor 202 will be set by the controller 600 to allow the area between the bars to fill with loose fibers. The bar conveyor 202 will then convey the loose fibers onto the release film 306 located on the pour table 208.

To determine the height of the bar conveyor 202, during the design of a particular board the required weight per square foot of recycled material must be determined. For an example, 100 ounces per square yard converted to 0.6944 pounds per square foot of process board is used. Since each supplier or run of recycled material may be different in its specific gravity or volumetric density, lab tests should be run on raw material samples to determine volumetric density. In this example, loosely packed raw fiber has a density of four pounds per cubic foot. Therefore, the required height of the application of fiber would be 0.1736 feet or 2.0832 inches. At a mold 316 speed set for 10 feet per minute and a board width of 8.5 feet, the bar conveyor speed is set to 10 feet per minute as well. The height of the bar conveyor 202 would then be set for 2.0832 inches. However, if the bar conveyor 202 speed is set to 20 feet per minute, and the mold 316 speed remains at 10 feet per minute, the bar conveyor 202 height would be adjusted to be 1.0416 inches. Further, adjustments to metering can be made by slight adjustments to the bar conveyor speed by adjusting the motor 606.

Then, the leveling rake 206 will be adjusted to level the top of the loose fibers as the loose fibers are conveyed onto the release film 306 on the pour table 208. The loose fibers will be leveled to be 0.1805 pounds per square foot. The necessary height of the mechanical assist 304 is calculated by determining the height of the loose fibers, skins and adhesives entering the mold 316. In this example, E-Glass weighs 153.9 lbs per cubic foot applied at a rate of 27.6 ounces per yard (27.6 ounces per yard=0.19167 pounds per square foot). The area is then divided by the weight to determine the height, which is 0.0012454 feet, which equals 0.014945 inches. The same calculation is done for the recycled carpet fiber weighing 73.9 lbs per cubic foot applied at a rate of 26 ounces per yard, which result in a height of 0.029309 inches.

To calculate the height of the layer of adhesive, a specific gravity of the polyurethane foam is used, with a standard formulation of 1.1. A specific gravity of any element is referenced from the specific gravity of water (1.0 at standard temperature and pressure). A specific gravity of 1.0 equates to 62.38737 pounds per cubic food (8.34 pounds per gallon), and accordingly, a specific gravity of 1.1 equates to 68.627 pounds per cubic foot. The weight of the adhesive, 1.2898 pounds, calculated above, is divided by 68.627 pounds per cubic foot for a layer height of 0.22548 inches. Accordingly, the mechanical assist 304 is set at a height of approximately 0.269734 inches, which is determined by adding the height of the loose fibers (0.029309 inches), the E-glass (0.014945 inches), and the adhesive (0.22548 inches).

In the mold, the adhesive saturates throughout the loose fibers and the applied skin. The height of the mold 316 can be set to be slightly greater than the desired ½ inch material sheet, for example 0.533 inches, to allow for excess material to be sanded, making the material sheet a desired thickness. The adhesive will then expand beyond the loose fibers and the skin as it cures. In this example, the thickness of the adhesive above the skin material averages 0.030 of an inch per side. This allows the adhesive to provide a clear area to sand without sanding into the structural composite.

Once the material sheets are formed in the mold, they are conveyed to an output 312. The material sheet is then preferably cured for a minimum of 24 hours prior to a sanding or finishing of the surfaces of the material sheet. The material sheets can then be sanded to the desired thickness and ripped with appropriate sawing equipment to desired shapes and sizes.

### Modified Embodiment

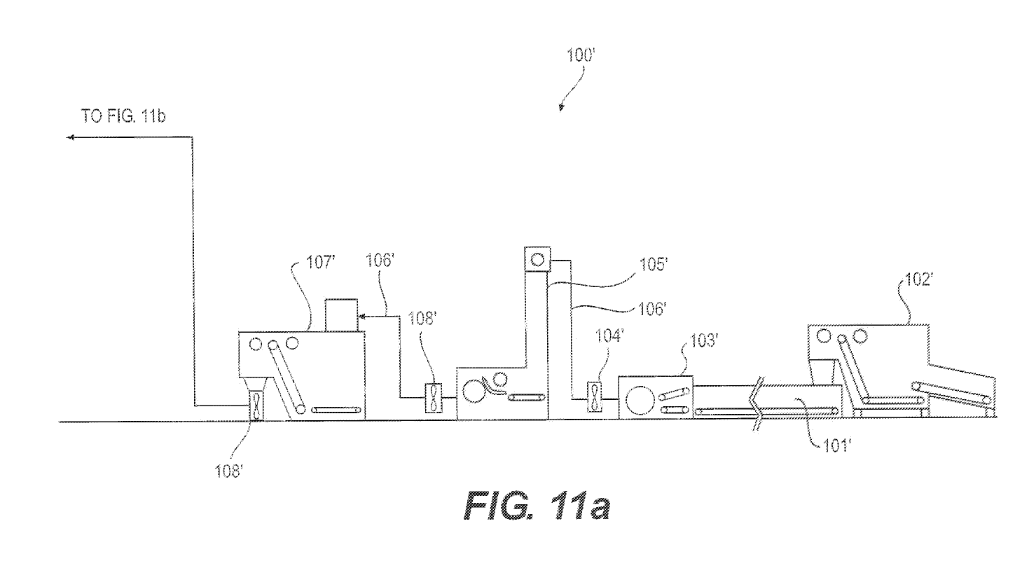

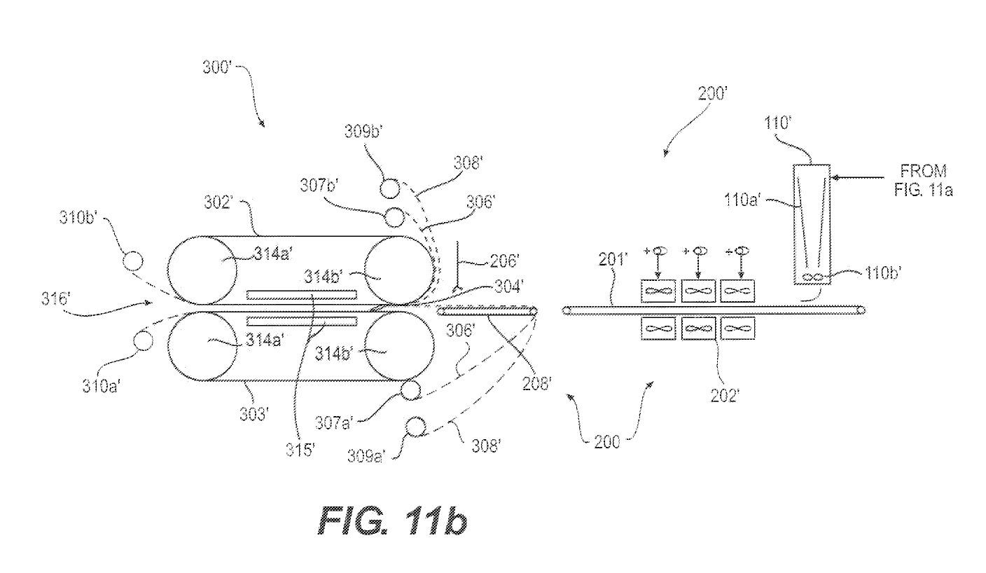

In a modified embodiment, a supply system 100′ provides loose fibers to a conveyor system 200′, which conveys the loose fibers to an area where resin is poured on the loose fibers. The conveyor system 200′ then continues to convey the loose fibers to a mold system 300′ to form a sheet of material. The overview of the modified system is shown in FIGS. 11a and 11b.

Resins within the scope of this invention can be defined as viscous liquids that are capable of hardening permanently to form a solid and thermoplastic solids that can be heated to liquid form and revert back to solid form upon cooling. Resins which, therefore, can be used within the scope of this invention include, for example, polymeric methylene diphenyl diisocyanate (PMDI), polyurethane, either with or without blowing agents, polyuria, polyaspartic, polyepoxides, thermoplastic polyurethane, and various polyolefins.

Supply System

In the supply system 100′, shown in FIG. 11a, bales of fibers are stored in multiple bale openers 102′, volumetrically dosed onto a collecting conveyor 101′ which feeds a picker 103′ that opens up partially the fiber and sends it pneumatically to multiple fine openers 105′. The fine openers open finely the fibers and then send them pneumatically via ducting 106 to a reserve 107′ which then sends the fibers pneumatically by blowers 108′ to a volumetric chute feed system 110′, which then feeds them to a conveyor system 200′ to have resin poured on the loose fibers. (FIG. 11b) In a preferred embodiment, the loose fibers are provided from discarded carpet segments; however, the loose fibers may be any other synthetic or natural fibers.

The bale opener 102′ can be a Laroche Model CHP and can include an inclined spike apron, an evening roll and a doffer roll. A conveyor feeds the bales of fiber to the inclined spike apron, which grabs large tufts of fiber off of the bales of fiber. The evening roll rotates in a fashion as to take the excess large tufts of fiber off of the inclined spike apron and send them back on the feed conveyor. The doffer roll grabs the large tufts of fibers carried by the inclined spike apron that have made it past the evening roll and sends them onto a collecting conveyor 101′. The collecting conveyor 101′ collects the partially opened tufts from all the bale openers 102 and feeds a picker 103′ that opens up even more of the fibers and sends them pneumatically via blower 104′ to multiple fine openers 105′. The fine openers 105′ open finely the fibers and then send them pneumatically via blower 106′ through ducting to a reserve 107′, which then sends them pneumatically to a volumetric chute feed system 110′. The picker 103′ can be a Laroche Model OH, and each of the fine openers 105′ can be a Laroche Model EXEL.

The fiber reserve 107′ is a component based on a Laroche bale breaker, but modified to achieve the desired results in the system of this invention. The fiber reserve has a condenser mounted on its top to enable pneumatically fed fiber to be separated from the transporting air and drop on its feed apron. A spike apron then takes tufts of fiber upward. Excess fiber tufts are taken off the spike apron due to an evening roll that runs in the opposite direction from that of the upward movement of the spike apron. A doffer roll running in the same direction as the spike apron, but at a faster speed, then doffs off the fiber tufts and sends them onto a perpendicularly inclined dosing conveyor. When the volumetric chute feed system 110′ is running low on fiber, the perpendicular inclined dosing conveyor feeds the fiber tufts to a fan, which then pneumatically transport them to the volumetric chute feed system 110′. Design consideration has been taken to enable, at the beginning of the perpendicular inclined dosing conveyor, introduction of hot air to initiate a moisture elimination process accomplished with a through air thermal oven 202′, which is discussed later. This feature can be turned on or off by the operator.

Volumetric chute feed system 110′ includes within its outer shell one or more vibration plates or walls 110a′ and a metering device in the form of adjustable bottom feed rolls 110b′. Loose fibers received at the upper end of the unit are gravity-fed down toward metering device 110b and are dropped onto conveyor 201′ as a uniform blanket or web of fibers. Vibrating plates 110a′ can be controlled to compress the loose fibers so as to increase or decrease the density of the fibers. Vibrating plates 110a and metering device 110b′ can work in conjunction to vary the thickness and density of the loose fiber blanket as desired. In more detail, in order to make the loose fiber web thinner or thicker, the gap between the bottom feed rolls can be made narrower or wider. In order to increase the density of the loose fiber web, the oscillating speed of the vibrating front wall can be increased or decreased to increase or decrease loose fiber web density. It is also possible to increase or decrease the rotation speed of fan 108′ to increase or decrease the density of the loose fiber web.

Conveyor System

The loose fibers in the volumetric chute feed system 110′ are fed to the belt 201′ of conveyor system 200 by rollers. The conveyor system 200′ conveys the loose fibers from the volumetric chute feed system 110′ to the mold system 300′. The conveyor system 200′ helps maintain the continuous flow of the loose fibers from the volumetric chute feed system 110′ to the mold system 300′.

The conveyor system 200′ includes, near the bottom of the volumetric chute feed system 110′, a through air thermal oven 202′. This oven flashes off excess moisture on the fiber and heats the fiber to a desired temperature prior to contact with the resin. The through air thermal oven 202′ consists of a combustion chamber where a natural gas burner is fired to heat up the process circulation air. Various ducts extend from this combustion chamber and lead down to individual top heating sections. These heating sections have perforated plates enabling hot air to be released from the top heating section and sucked through the loose fiber web thanks to correspondent suction boxes beneath them. These suction boxes are ducted to fans which recycle some of the process circulation air back into the combustion chamber. The other portion is exhausted to prevent carbon dioxide or carbon monoxide buildup. The proportion that is recirculated can be adjusted by the operator.

By heating the loose fiber web prior to resin application, fiber moisture can be brought to a compatible level for the resin application. Fiber temperature can also be raised to a compatible level for the resin application. Typically, for a closed-cell polyurethane resin system, it has been found that loose fiber web temperatures between 90° F. to 100° F. are most effective.

The loose fiber conveys through the through air thermal oven 202′ and onto pour table 208′. The pour table 208′ is a conveyor belt used to move the loose fibers to an area where resin is poured on the loose fibers and further to the mold system 300′.

Resin Application System

The loose fibers continue to be conveyed by the pour table 208′ toward the mold system 300′. Prior to entering the mold system 300′, a resin is added to the loose fibers.

In a preferred embodiment, the resin is stored in a storage container and poured on the loose fibers via a multi-component high pressure static mixhead. The resin is poured onto the loose fibers located on the pour table 208 at a rate to create a defined level of the resin as it is poured. Therefore, the layer of resin poured will have a certain height.

In a preferred embodiment, where a 3 component closed-cell polyurethane system is used, high pressure metering units dose temperature controlled isocyanate, polyol and pigment dispersion to a 3 component high pressure impingement mixhead, similar to a CANNON USA FPL24. This mixhead is mounted on a fixed frame. A flexible hose is connected to the output of the mixhead. At the opposite end of the flexible hose, a spray nozzle is installed. This opposite end is attached to a single axis linear reciprocating robot unit, similar to that offered by RANGER AUTOMATION SYSTEMS INC.

Using the single axis linear reciprocating robot unit's controller, it is possible to enable the spray nozzle to spend more time in one specific position than another. Hence in operations, resin sprayed via the reciprocating spray nozzle is applied throughout the width of the loose fiber web. It is then possible, for example, to lessen the time spent by the dispensing spray nozzle at the edges in order to maintain a uniform application rate throughout the width of the loose fiber web. Hence, the resin is poured onto the loose fibers located on the pour table 208′ at a rate to create a defined level of the resin as it is poured. Therefore, the layer of resin poured will have a certain height.

In a preferred embodiment, a foaming mixture of isocyanate and polyol (hereinafter polyurethane foam) is used as the resin. This produces materials that are exceptionally hard, strong, and durable. Of course, any other materials, such as those described earlier, can be used if they produce satisfactory results.

Mold System

After the resin has been poured on the loose fibers, the pour table 208′ conveys the loose fibers mixed with the resin to the mold system 300′. The mold system 300′ includes a pre-compression section 304′. This metal plate pre-compresses the loose fibers mixed with the resin. As discussed above, the resin is added prior to entering the pre-compression section 304′ of the mold system 300′. The pre-compression section 304′ is designed to provide compression of the loose fibers and resin, substantially eliminating air in the mixture prior to entering the mold, as further described below.

Front and back gauges of the pre-compression section 304′ are adjustable to produce a variety of sizes of the material. The gauges are adjusted through the mold 316′, discussed more fully below, by either lifting the pre-compression section 304′ to accommodate a higher gauge or by lowering the pre-compression section 304′ to accommodate a lower gauge. Alternatively, the loose fibers poured with resin may enter the mold 316′ without having the pre-compression section apply any pre-compression.

Typically, boards are produced with a pound per cubic foot (PCF) density in the range of 20 PCF to 50 PCF, for example. Then, it must be determined what thickness is desired for the board (generally ¼″, ⅜″, ½″, ⅞″, 1″ and 1¼″). Further, as discussed below, skins may be added to meet other structural requirements of the boards. Pounds per square foot of the board is determined by taking the PCF and dividing it by the desired thickness. Then, the pre-compression section 304′ will be set to a height to allow only the loose fibers, skins and resin to pass under the pre-compression section 304′ to remove air.

The mold 316′ comprises a set of steel belts 302′, 303′, as shown in FIG. 11b. Each steel belt 302′, 303′ is fitted around at least two rollers 314a′, 314b′. Each steel belt 302′, 303′ is moved by the rollers 314a′, 314b′. The belts 302′, 303′ can be backed by movable platens 315′ to reinforce the molding effect. If a non-expanding resin is used, the platens and belts can be adjusted to produce the molding force.

The loose fibers poured with resin are conveyed through the mold 316′. As the loose fibers are conveyed through the mold 316′, the resin chemically reacts within the loose fibers, forming the material sheet. The steel belts 302′, 303′ of the mold 316′ convey the loose fibers mixed with the resin through the mold 316′ while the resin is cured. The mold 316′ limits the thickness of the composite in the vertical direction.

As shown in FIG. 11b, the mold system 300′ further includes at least one roller, preferably two, 307a′, 307b′, which store release film and/or paper (hereinafter referred to as release film 306′. The release film 306′ is preferably made of polyethylene. The release film 306′ protects the material sheet from potentially sticking to the steel belts 303′ after being formed. Preferably, the release film 306′ is provided on a roller 307a′ below the loose fibers and on a roller 307b′ above the loose fibers poured with resin. This will allow the release film 306′ to be located on both sides of the loose fiber. As shown in FIG. 11b, the release film 306′ is wound around the pour table 208 so that the fibers are conveyed directly onto the release film 306 on the pour table 208′ (unless a lower skin is used, as discussed below.) Further, if release film 306′ is provided on a roller 307b′ above the loose fibers, the release film 306′ is wound around roller 314b′ and is provided above the loose fibers after they have been poured with resin. The release film allows the product to cleanly release from the belts 302′.

The release film 306′ is preferably a reusable type of release film. After the release film 306′ is fed through and exits the mold, the release film 306′ originally fed from roller 307a′ will be wound around roller 310a′, and the release film 306′ originally fed from roller 307b′ will be wound around roller 310b′, as shown in FIG. 11b, to be used again.

Further, as shown in FIG. 11b, the mold system 300′ may also include at least one roller, preferably two, 309a′, 309b′, which may store a skin 308′. As shown in FIG. 11b, one roller 309a′ will feed the skin 308′ so that the release film 306′ is below the skin, and the loose fibers are poured onto the skin 308′. The other roller 309b′ will feed the skin 308′ around the release film 306′, which is wound around the roller 314b′, to be located on top of the loose fibers and below the release film 306′. The skins 308′ provide further structural support for the material sheets and will be chosen based on the desired properties of the material sheet

As will be understood by one of ordinary skill in the art, a single skin 308′ may be provided below the fibers with release film 306′ provided above the fibers. Further, multiple skins 308′ may be provided on a variety of rollers. As will be understood by one of ordinary skill in the art, a variety of combinations may be made between the release film 306′ and the skins 308′ provided to form the material sheet.

The skins 308′ can be a porous technical fabric. After the skin is laid on or below the loose fibers, the resin will expand through the pores of the skin 308′. The skin 308′ is then embedded in the resin on top of the loose fibers. If multiple skins 308′ are used, the resin will pass through the pores of all of the skins 308′. The skins 308′ will then be embedded in the resin, layered on top of the loose fibers. Refer, for example, to FIGS. 10a and 10b, which show the layers of various types of boards. FIG. 10a shows a sheet formed with loose fibers and resin, without a skin. FIG. 10b shows a material sheet formed with multiple layers of skins 308 and loose fibers embedded in the resin.

The skins 308′ may include, but are not limited to, for example, E-glass veil skin, woven E-glass roven skin, carbon fiber technical skins, Kevlar, Nomex fire retardant skin, non-woven E-glass roven skin, embossed wood grain skin, polyester cloth, cotton cloth, polypropylene veil mesh, aluminum screen, nylon mesh, paper, tissue paper, blast resilient skin, and fragmentation resistant skin. Any skin may be used that is formed of an inert, fibrous and porous material.

For example, FIG. 10a shows a material sheet formed out of loose fibers mixed with resin 902. FIG. 10b shows a material sheet formed with loose fibers mixed with resin 902, with a layer of non-woven E-glass Roven 904 in the resin and a layer of E-glass veil 906 in the resin.

Controller System

As with the previous embodiment, the system is provided with at least one controller; however, as understood by one of ordinary of skill in the art, multiple controllers that interact with each other may be provided. The controller controls the various aspects of the system as a whole. The controller can be a suitably programmed microprocessor.

All of the components of the system, including, for example, motors, conveyor belts, chemical flow rate valves, etc., are program controlled based on sensor and/or operator inputs. This level of automation allows the sequencing of events to avoid process stalls as well as product consistency. The controller is connected to a control panel for an operator to input the desired commands for running the entire system.

Thus, there has been shown and described a new and useful system for creating material sheets, using loose fibers from carpet or other textiles. Although this invention has been exemplified for purposes of illustration and description by reference to certain specific embodiments, it will be apparent to those skilled in the art that various modifications, alterations, and equivalents of the illustrated examples are possible.

What is claimed is:

1. A method for creating a material sheet with fibers, comprising the steps of:
feeding a layer of loose fibers to a conveyor;
applying resin to the loose fibers, the resin being capable of bonding to the loose fibers;
conveying the loose fibers and resin to a mold; and
allowing the resin applied to the loose fibers to fill the mold and then solidify to harden in a desired thickness.

2. The method according to claim 1, further comprising:
forming the conveyed loose fibers in a desired height prior to applying the resin to the loose fibers.

3. The method according to claim 1, further comprising:
forming the conveyed loose fibers in a desired area weight prior to applying the resin to the loose fibers.

4. The method according to claim 1, wherein the loose fibers are fed continuously to the mold.

5. The method according to claim 1, further comprising:
compressing the loose fibers prior to the loose fibers entering the mold.

6. The method according to claim 1, further comprising:
applying a skin to at least one side of the loose fibers mixed with the resin prior to entering the mold,
wherein the resin passes through the skin to embed the skin in the resin.

7. The method according to claim 6, wherein the skin may be any one of E-glass veil skin, woven E-glass roven skin, carbon fiber technical skin, Kevlar, Nomex fire retardant cloth, non-woven E-glass roven skin, embossed wood grain skin, blast resilient skin, and fragmentation resistant skin.

8. The method according to claim 7, wherein multiple skins may be layered above and below the loose fibers.

9. The method according to claim 1, wherein the loose fibers comprise post-industrial and/or post-consumer waste fibers from discarded carpet segments.

10. The method according to claim 1, wherein the resin comprises polyurethane.

11. The method according to claim 1, wherein the percent by weight of loose fibers is between 10% and 50% of all the materials forming the sheet.

12. An article of manufacture produced by the method according to claim 1.

13. An article of manufacture suitable for use as a wood substitute, comprising a sheet of composite material consisting essentially of a resin which has become bound to a layer of non-matted, loose fibers.

14. The article of manufacture of claim 13, wherein the loose fibers comprise post-industrial and/or post-consumer waste fibers from discarded carpet segments.

15. The article of manufacture of claim 13, wherein the resin comprises polyurethane.

16. The article of manufacture of claim 13, wherein the article of manufacture contains a skin on at least one surface of the layer of fibers,
wherein the resin passes through the skin such that the skin is embedded in the resin.

17. The article of manufacture of claim 16, wherein a mixture of the resin and the fibers is provided on one side of the skin and only the resin is provided on the other side of the skin.

18. The article of manufacture of claim 16, wherein the skin may be any one of E-glass veil skin, woven E-glass roven skin, carbon fiber technical skin, Kevlar, Nomex fire retardant cloth, non-woven E-glass roven skin, embossed wood grain skin, blast resilient skin, and fragmentation resistant skin.

19. The article of manufacture of claim 13, wherein the percent by weight of loose fibers is between 10% and 50% of all the materials forming the article.

20. A system for creating a material sheet with fibers, the system comprising:
a supplying system that supplies loose fibers;
a conveyor system that conveys the loose fibers;
a resin application system that applies resin to the loose fibers; and
a mold system that allows the resin applied to the loose fibers to fill the mold and then solidify to harden in a desired thickness,
wherein the supplying system supplies the loose fibers to the conveyor system to be conveyed to the resin application system and then the mold system.
